(19) United States
(12) Patent Application Publication
(10) Pub. No.: US 2008/0244394 A1
(43) Pub. Date: Oct. 2, 2008

(54) DISPLAY AND LAYOUT FLOW OF RELATIVELY POSITIONED USER INTERFACE ITEMS

(76) Inventors: John M. Boyer, Victoria (CA); Christopher D. Lamb, Victoria (CA); David F. Manning, Victoria (CA); Michael C. Mansell, Langford (CA)

Correspondence Address: HOFFMAN WARNICK LLC, 75 STATE ST, 14TH FLOOR, ALBANY, NY, 12207, US

(21) Appl. No.: 11/693,364

(22) Filed: Mar. 29, 2007

(51) Int. Cl. G06F 3/00

(52) U.S. Cl. 715/700

(57) ABSTRACT

An improved solution for managing a user interfaces is provided. Aspects of the invention include the display and layout flow of relatively positioned user interface items. In an embodiment of the invention, a method of managing a user interface is provided, the method includes: obtaining a document for a rendition, wherein the document includes a plurality of user interface items; positioning a first user interface item at a first location on the document; setting a display property value of the first user interface item to one of: on or off; and relatively positioning from the first user interface item a second user interface item at a second location, wherein the relative positioning is independent of the display property value.

### FIELD OF THE INVENTION

The present invention generally relates to managing user interfaces, and more specifically relates to the display and layout flow of relatively positioned user interface items.

### BACKGROUND OF THE INVENTION

The designers of user interfaces, such as screens on websites, typically employ languages such as HyperText Markup Language (HTML), Extensible Forms Description Language (XFDL), and/or Cascading Style Sheets (CSS) language to describe in a document the appearance of the user interface on a rendering device. The content of the document describes the components of a user interface in terms of user interface (UI) item(s) and their rendition properties. When using, for example, HTML and CSS to arrange the positions of the various UI items the available display “property” is limited to three distinct values: “none”, “block” and “inline”. As shown in FIG. 1A, a “block” display is selected which locates UI items 104A, 104B essentially in a vertically flowing appearance on a document 102 that is shown on the rendering device 100. In other words, with “block” display, a UI item 104B will be placed below a preceding UI item 104A and then shifted over to the leading margin 106. Similarly, as shown in FIG. 1B, with “inline” display, the UI items 104A, 104B essentially are rendered in a horizontally flowing layout of the document 102 by the rendering device 100. In other words, each UI item 104B is rendered at the same vertical level 108 as, and horizontally trailing to, its preceding UI item 104A of the document 102 by the rendering device 100.

In HTML and CSS these three display property values are effectively mutually exclusive in the way in which the UI items are assembled in the layout of the HTML and CSS document. For when the value is set to “none” for the instant UI item, that particular UI item(s) is not only removed entirely from display on the document, but also none of the “remaining” viewable UI item(s) (i.e., UI items with a “block” or “inline” settings) may be positioned relative to the non-displayed UI item (i.e., UI item with a “none” setting). The non-displayed UI item is completely removed from the document (and display) for all intents and purposes. Thus, the viewable UI items may be arranged only in relation to other viewable UI items.

These limitations are problematic for being both inefficient and inflexible. As web user interfaces become more complicated, web authors are seeking more capabilities and flexibility as to how various elements of a user interface, such as a web document, are arranged. For example, for a myriad of reasons, often user interfaces are required to have different appearance iterations for different uses, users, security levels, and the like. Yet, due to the shortcomings of the current methodologies, a web site author is either highly limited as to how he/she can arrange the various UI items in relation to each other and/or must expend an inordinate amount of resources explicitly designing user interface presentations for each, and every, display appearance iteration that may be desired.

In view of the foregoing, a need exists to overcome one or more of the deficiencies in the related art.

### BRIEF SUMMARY OF THE INVENTION

Aspects of the invention provide an improved solution for managing a user interface.

A first aspect of the invention provides a method of managing a user interface, the method comprising: obtaining a document for a rendition, wherein the document includes a plurality of user interface items; positioning a first user interface item at a first location on the document; setting a display property value of the first user interface item to one of: on or off; and relatively positioning from the first user interface item a second user interface item at a second location, wherein the relative positioning is independent of the display property value.

A second aspect of the invention provides a system for managing a user interface, the method comprising: a system for obtaining a document for a rendition, wherein the document includes at least two user interface items; a system for positioning a first user interface item at a first location on the document; a system for setting a display property value of the first user interface item to one of: on or off; and a system for relatively positioning from the first user interface item a second user interface item at a second location, wherein the system for relative positioning is independent of the display property value.

A third aspect of the invention provides a computer program comprising program code stored on a computer-readable medium, which when executed, enables a computer system to implement a method of managing a user interface, the method comprising: obtaining a document for a rendition, wherein the document includes a plurality of user interface items; positioning a first user interface item at a first location on the document; setting a display property value of the first user interface item to one of: on or off; and relatively positioning from the first user interface item a second user interface item at a second location, wherein the relative positioning is independent of the display property value.

A fourth aspect of the invention provides a method of generating a system for managing a user interface, the method comprising: providing a computer system operable to: obtain a document for a rendition, wherein the document includes a plurality of user interface items; position a first user interface item at a first location on the document; set a display property value of the first user interface item to one of: on or off; and relatively position from the first user interface item a second user interface item at a second location, wherein the relative positioning is independent of the display property value.

A fifth aspect of the invention provides a data processing system for managing a user interface, comprising: a processing unit; a bus coupled to the processing unit; and a memory medium coupled to the bus comprising program code, which when executed by the processing unit causes the data processing system to: obtain a document for a rendition, wherein the document includes a plurality of user interface items; position a first user interface item at a first location on the document; set a display property value of the first user interface item to one of: on or off; and relatively position from the first user interface item a second user interface item at a second location, wherein the relative positioning is independent of the display property value.

A sixth aspect of the invention provides computer software embodied in at least one propagated signal for managing a user interface, the at least one propagated signal comprising instructions for causing at least computer system to: obtain a document for a rendition, wherein the document includes a plurality of user interface items; position a first user interface item at a first location on the document; set a display property value of the first user interface item to one of: on or off; and relatively position from the first user interface item a second user interface item at a second location, wherein the relative positioning is independent of the display property value.

A seventh aspect of the invention provides a business method for managing a user interface, the business method comprising: managing a network that includes at least one computer system that performs the process described herein; and receiving payment based on the managing.

The illustrative aspects of the invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIGS. 1A and 1 B show renditions having a block flow and an inline flow according to related art.

FIG. 2 shows an illustrative environment for employing a method of managing a user interface according to an embodiment of the invention.

FIGS. 3A-3D show various renditions employing the method of managing a user interface according to an embodiment of the invention.

FIG. 4A-4B show various renditions employing the method of managing a user interface according to an embodiment of the invention.

FIG. 5A-5B show various renditions employing the method of managing a user interface according to an embodiment of the invention.

FIGS. 6 shows an illustrative data flow for managing a user interface according to an embodiment of the invention.

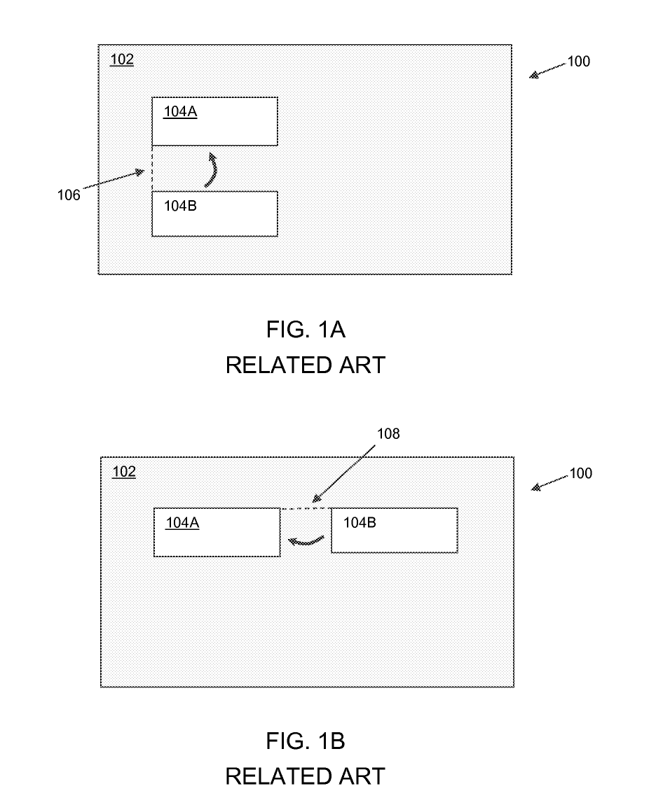

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide an improved solution for managing a user interface. Aspects of the invention include the display and layout flow of relatively positioned user interface items. In an embodiment of the invention, a method of managing a user interface, the method includes: obtaining a document for a rendition, wherein the document includes a plurality of user interface items; positioning a first user interface item at a first location on the document; setting a display property value of the first user interface item to one of: on or off; and relatively positioning from the first user interface item a second user interface item at a second location, wherein the relative positioning is independent of the display property value. As used herein, unless otherwise noted, the term “set” means one or more (i.e., at least one); and the phrase “any solution” means any now known or later developed solution.

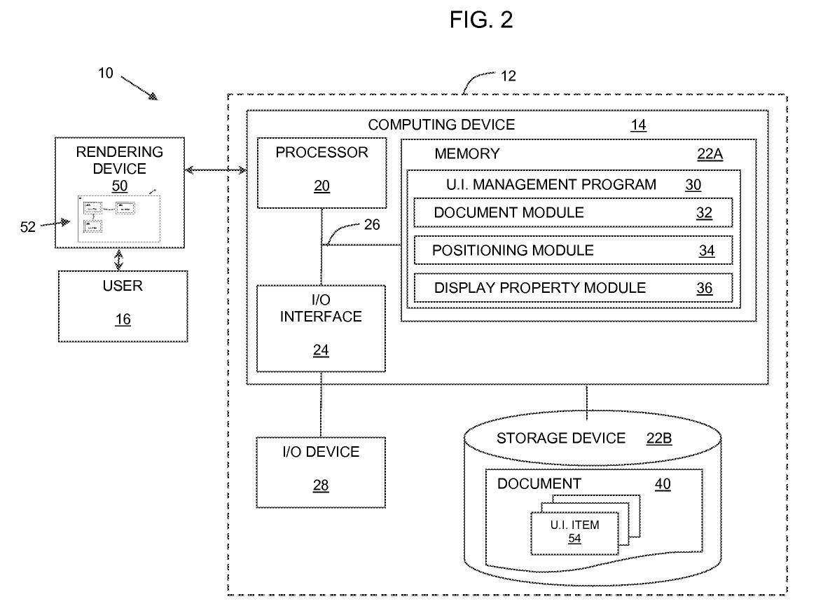

Turning to the drawings, FIG. 2 shows an illustrative environment 10 for managing a user interface 52 according to an embodiment of the invention. To this extent, environment 10 includes a computer system 12 that can perform the process described herein in order to manage a user interface 52. In particular, computer system 12 is shown including a computing device 14 that comprises a user interface management program 30 (“U.I. Management Program”), which makes computing device 14 operable for managing a user interface 52, by performing the process described herein.

Computing device 14 is shown including a processor 20, a memory 22A, an input/output (I/O) interface 24, and a bus 26. Further, computing device 14 is shown in communication with an external I/O device/resource 28 and a storage device 22B. In general, processor 20 executes program code, such as user interface management program 30, which is stored in a storage system, such as memory 22A and/or storage device 22B. While executing program code, processor 20 can read and/or write data, such as data 38 to/from memory 22A, storage device 22B, and/or I/O interface 24. Bus 26 provides a communications link between each of the components in computing device 14. I/O device 28 can comprise any device (e.g., rendering device 50) that transfers information between a user 16 and computing device 14 and/or other elements (e.g., user interface 52, etc.) and computing device 14. To this extent, I/O device 28 can comprise a user I/O device to enable an individual user 16 to interact with computing device 14 and/or a communications device to enable an element, such as a user interface 52, to communicate with computing device 14 using any type of communications link. For example, rendering device 50 may comprise a screen.

In any event, computing device 14 can comprise any general purpose computing article of manufacture capable of executing program code installed thereon. However, it is understood that computing device 14 and user interface management program 30 are only representative of various possible equivalent computing devices that may perform the process described herein. To this extent, in other embodiments, the functionality provided by computing device 14 and user interface management program 30 can be implemented by a computing article of manufacture that includes any combination of general and/or specific purpose hardware and/or program code. In each embodiment, the program code and hardware can be created using standard programming and engineering techniques, respectively.

Similarly, computer system 12 is only illustrative of various types of computer systems for implementing aspects of the invention. For example, in one embodiment, computer system 12 comprises two or more computing devices that communicate over any type of communications link, such as a network, a shared memory, or the like, to perform the process described herein. Further, while performing the process described herein, one or more computing devices in computer system 12 can communicate with one or more other computing devices external to computer system 12 using any type of communications link. In either case, the communications link can comprise any combination of various types of wired and/or wireless links; comprise any combination of one or more types of networks; and/or utilize any combination of various types of transmission techniques and protocols.

As discussed herein, user interface management program 30 enables computer system 12 to manage a user interface 52. To this extent, user interface management program 30 is shown including a document module 32, a positioning module 34, and a display property module 36. Operation of each of these modules is discussed further herein. However, it is understood that some of the various modules shown in FIG. 2 can be implemented independently, combined, and/or stored in memory of one or more separate computing devices that are included in computer system 12. Further, it is understood that some of the modules and/or functionality may not be implemented, or additional modules and/or functionality may be included as part of computer system 12.

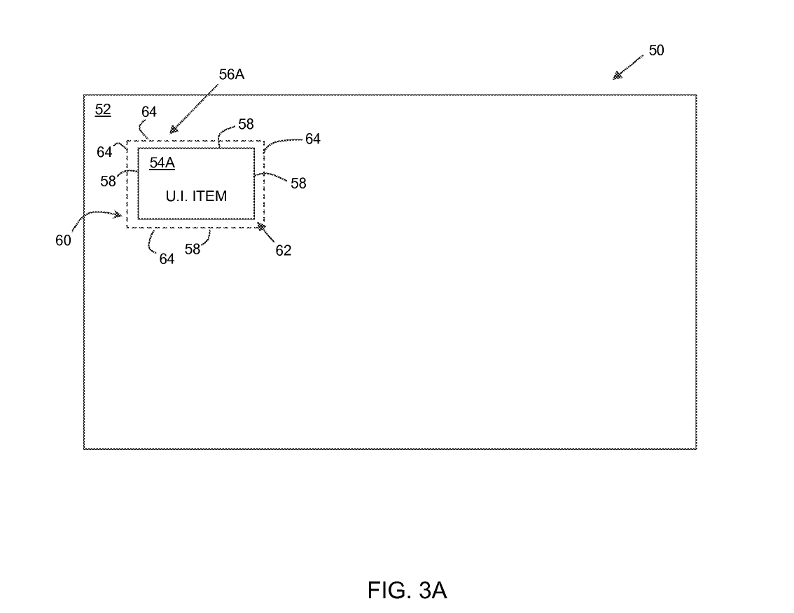

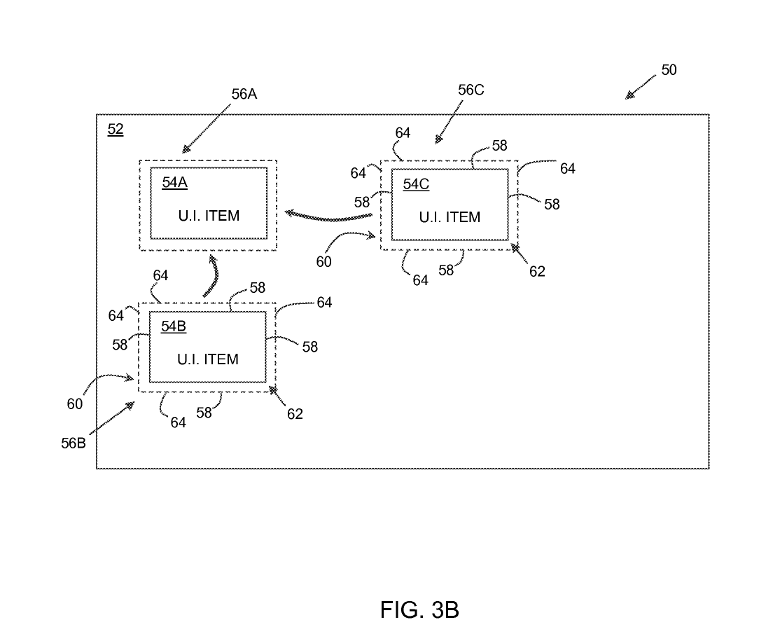

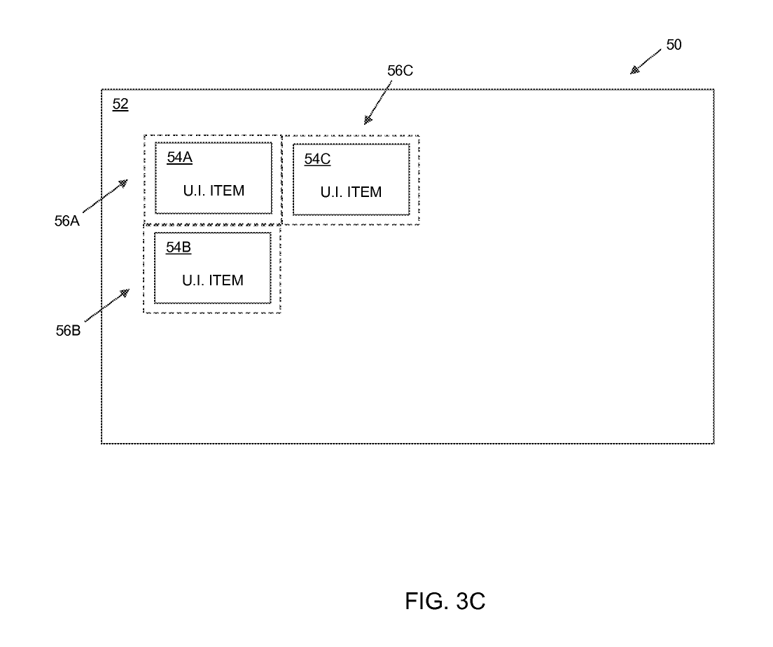

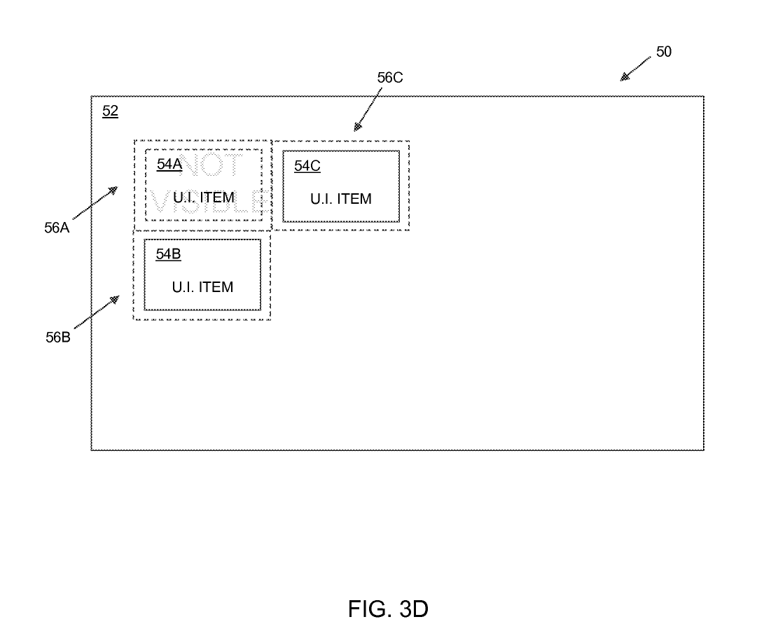

Aspects of the invention provide an improved solution for managing a user interface 52. To this extent, FIGS. 3A through 3D, FIGS. 4A and 4B, and FIGS. 5A and 5B show various embodiments of rendering devices 50 showing user interfaces 52 that employ the modules of user interface management program 30 (FIG. 2), respectively, according to embodiments of the invention. For example, a user 16 (FIG. 2)(e.g., programmer, web author, website designer, employee, etc.) may wish to manage one, or more, user interfaces 52, wherein managing may include, for example, adding, creating, editing, deleting, altering, and/or the like of the user interface 52. In any event, as FIG. 3A depicts a document (e.g., webpage) is obtained for the user interface 52. The document 40 may include a plurality of user interface (U.I.) items 54, such as U.I. item 54A. For example, U.I. item 54A may be rectangular in shape having edges 58 (e.g., top, bottom, left, right).

There are a variety of types of U.I. items 54 available for placement on the document 40. Types of U.I. items 54 include a button, a label, a toolbar, a line, a check, tree control, a field (e.g., for text), a slider, a popup, a checkgroup, a radiogroup, a panel (or pane), and a table. Some of the U.I. item 54 types (e.g., a table, tree control, a panel, a checkgroup, a radiogroup, a toolbar, and/or a page) may be considered a container for containing, or grouping, a plurality of other U.I. items 54. For example, a table U.I. item 54, as the name connotes, is a U.I. item 54 comprises a plurality of field U.I. items 54 presented in a tabular arrangement. In this manner, various U.I. items 54 may be grouped and/or nested with other U.I. items 54.

U.I. item 54A may further comprise a bounding box 60 having four edges 64 (e.g., left, right, top, bottom). As shown in FIG. 3A, the bounding box 60 is typically a rectangular area surrounding the U.I. item 54 thereby creating an interstitial space, or buffer, 62 between the edges 64 of the bounding box 60 and the edges 58 of the U.I. item 54. The bounding box 60, although not typically viewable to the user 16 (FIG. 2) on the user interface 52 (as denoted by dotted line) allows for the positioning of the edges 64 of bounding boxes 60 of various U.I. items 54 so as to provide a buffering space (e.g., pixels of padding) between the visible U.I. items 54 and their edges 58. This typically may be done for visual appeal purposes on the user interface 52.

In any event, as shown in FIG. 3A for example, a first U.I. item 54A is positioned at a first location 56A on the document 40. As FIG. 3B shows, a second U.I. item 54B is relatively positioned at a second location 56B, wherein the relative positioning of the second U.I. item 54B is done from, or in relation to, the first U.I. item 54A (as denoted by arrow). Similarly, a third U.I. item 54C may be relatively positioned at a third location 56B, wherein the relative positioning of the third U.I. item 54C is done from, or in relation to, the first U.I. item 54A (as denoted by another arrow). Although the relative positioning of only two U.I. items 54B, 54C from a single U.I. item 54A is shown in block placement and inline placement respectively, it should be clear that a near infinite variety, of positioning and relative positioning of U.I. items 54 to each other on documents 40 for rendering device 50, employing for example block and/or inline layoutflows is available under aspects of the present invention. For example, other additional U.I. items 54 may be relatively positioned from the first U.I. item 54A, from the second U.I. item 54B, and/or from the third U.I. item 54C.

Commands are available, for example in XFDL, that provide alignment and expansion/contraction to U.I. items 54. The edge 64 of one bounding box 60 to the edge 64 of another bounding box 60, as shown in FIG. 3C, may be aligned to each other. For example, the command “alignl2l” stands for “align left to left”, thereby causing the left edge 64 of the U.I. item 54 being aligned to be set equal to the location of the left edge 64 of the “target” U.I. item 54. Similarly, the keyword “after” comprises aligned the top edges 64 of two U.I. items 54 and to put the leading edge of the U.I. item 54 being relatively positioned beyond a trailing edge 64 of the target U.I. item 54 by a predetermined number of pixels of padding 62. In a left-to-right locale, the leading edge 64 is the ledge edge and the trailing edge 64 is the right edge 64. Thus, in a left-to-right locale, relatively positioning U.I. item 54D after U.I. item 54A comprises that U.I. item 54C will appear to the right of U.I. item 54A with a few pixels of padding between the right edge 64 of U.I. item 54A and the left edge 64 of U.I. item 54C.

Similarly, location specifiers are available for positioning U.I. items 54 in a vertical arrangement. For example, “alignt2b” comprises aligning the top edge 64 of an U.I. item 54 with the bottom edge 64 of the target U.I. item 54. Relatively positioning the U.I. item 54B “below” another U.I. item 54A comprises aligning the leading edges 64 of the two U.I. items 54A, 54B and positioning the top edge 64 of the U.I. item 54B a few pixels of padding 62 beneath the bottom edge 64 of U.I. item 54A. Various other U.I. item 54 location, or position, identifiers are available which allow for the precise relative positioning between the left, center, and/or right of two U.I. items 54; between the top, center and/or bottom of two U.I. items 54; and, above, below, after, before, and both vertical and horizontal commands to expand the width or height of a U.I. item 54 to achieve alignment of U.I. items 54.

Under aspects of the present invention a display property value of a U.I item 54 may be set to one of: on or off. For example, as shown in FIG. 3D, the display property value of the first U.I. item 54A is set to “off”. In this manner, while at least one U.I. item 54 may be non-visible to the user 16 (FIG. 2)(e.g., first U.I. item 54A), the relative positioning of other U.I. items (e.g., second U.I. item 54B, and/or third U.I. item 54C) from the non-visible U.I. item 54A is independent of the display property value setting of the U.I. item 54. For example, the edges 58 of U.I. item 54A and/or the edges 64 of bounding box 60 of U.I. item 54A may still be used for positioning of other U.I. items and their concomitant elements (e.g., edges 58, 64).

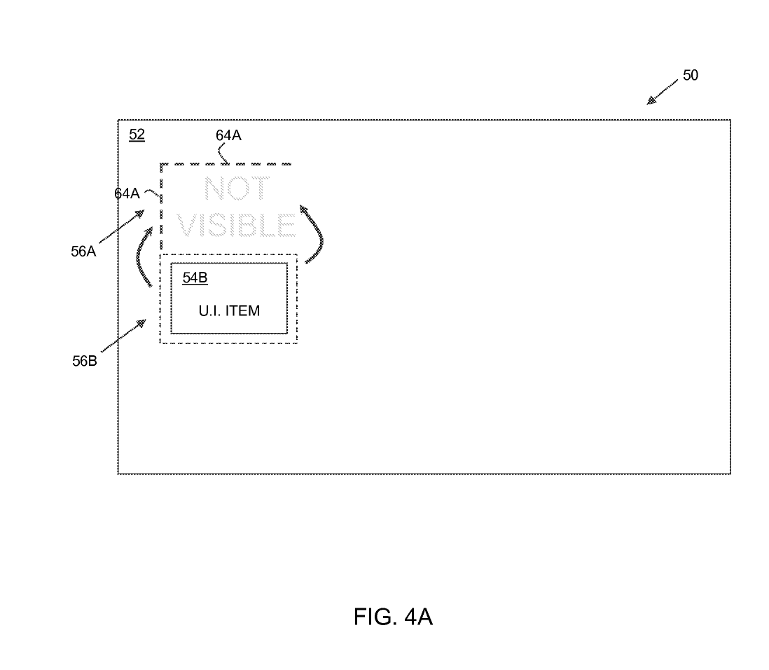

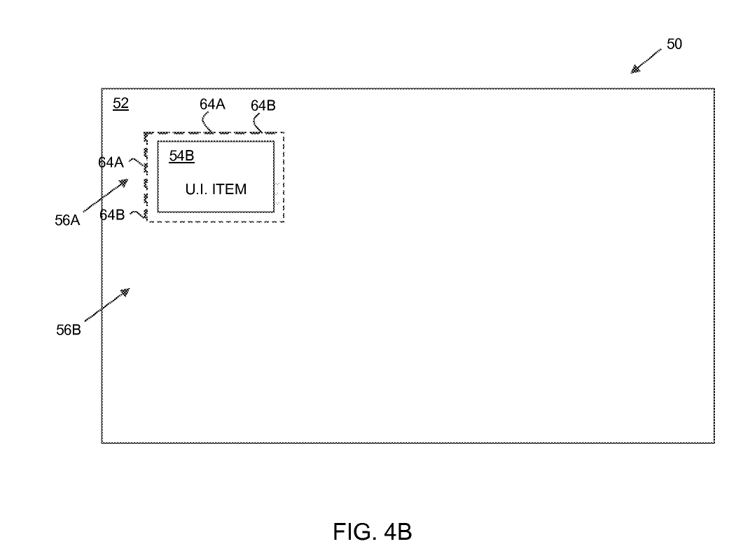

In another embodiment, aspects of the invention are shown in FIGS. 4A and 4B wherein a user interface 52 includes a document 40 having a plurality of U.I. items 54A, 54B positioned therein. The first U.I. item 54A has been positioned at a first location 56A and has a display property value set to “off”, and therefore is not shown in FIG. 4A for clarity purposes only. Upon a display property value being set to “off”, a height and width of the first U.I. item 54A or bounding box 60 thereof is set to “zero”. In this manner, as shown in FIG. 4A, the first U.I. item 54 is effectively reduced to a leading left edge 64A and a top edge 64. In other words, the first U.I. item 54 collapses to two edges 64A that are available for continued relatively positioning thereto by other U.I. items 54B. In this manner, when display property value is set to “off” for a U.I. item 54, various location identifiers are adjusted. For example, if a U.I. item 54 is relatively positioned to the right or bottom edge 64 of a U.I. item 54 that is now non-visible (i.e., display property value is set to “off”), then the width and height having been set to “zero” causes the right edge to overlay the left and the bottom edge to overly the top edge, as shown in FIG. 4B. Effectively, the non-visible (e.g., first) U.I. item 54A no longer exists on the document 40.

Relative positioning keywords, or identifiers, such as “after” and “below” may be amended when the target U.I. item 54 has its display property value set to “off”. For example, in the case where a U.I. item 54, termed “A”, has its display property value set to “off”, the term “B below A” is reinterpreted, or now comprises, as “B align top to top with A”. Similarly, the term “B after A” is reinterpreted, or now comprises, as “B align lead to lead with A”; wherein “lead” comprises “left” in a “left-to-right” locale and “right” in a “right-to-left” locale.

In another embodiment, the invention provides a revised method for calculating a maximum width or height for a U.I. item 54. Calculating a maximum width or height, the U.I. item 54 may employ entailing a container-type U.I. item 54 (i.e., table, panels, checkgroup, radiogroup, toolbar, or page) in the calculation. If the display property value setting is “off” for any of the “child” U.I. item 54, when performing a maximum width/height calculation, under aspects of the method, those particular non-visible U.I. item(s) 54 are ignored. In this manner, a more accurate calculation is performed.

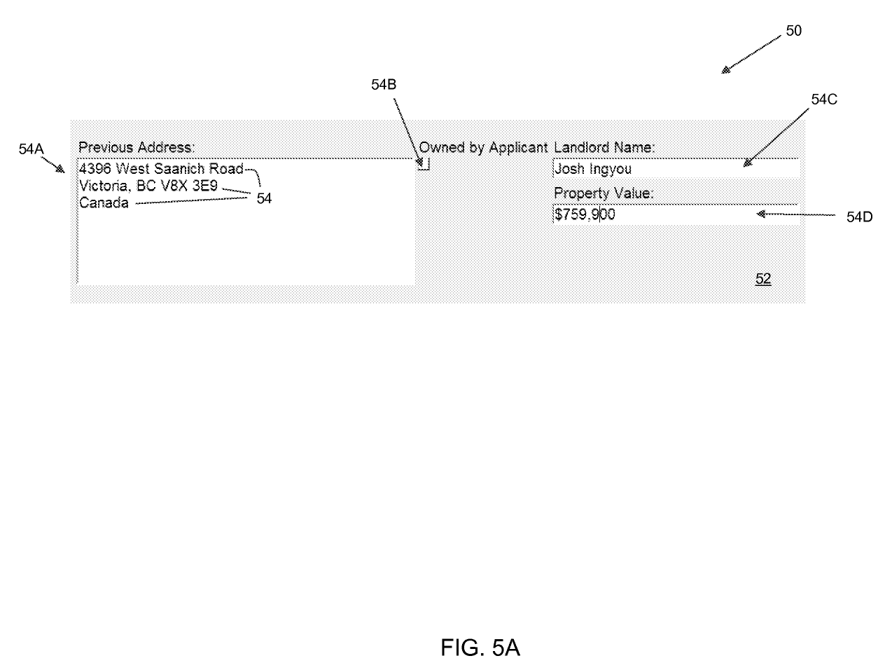

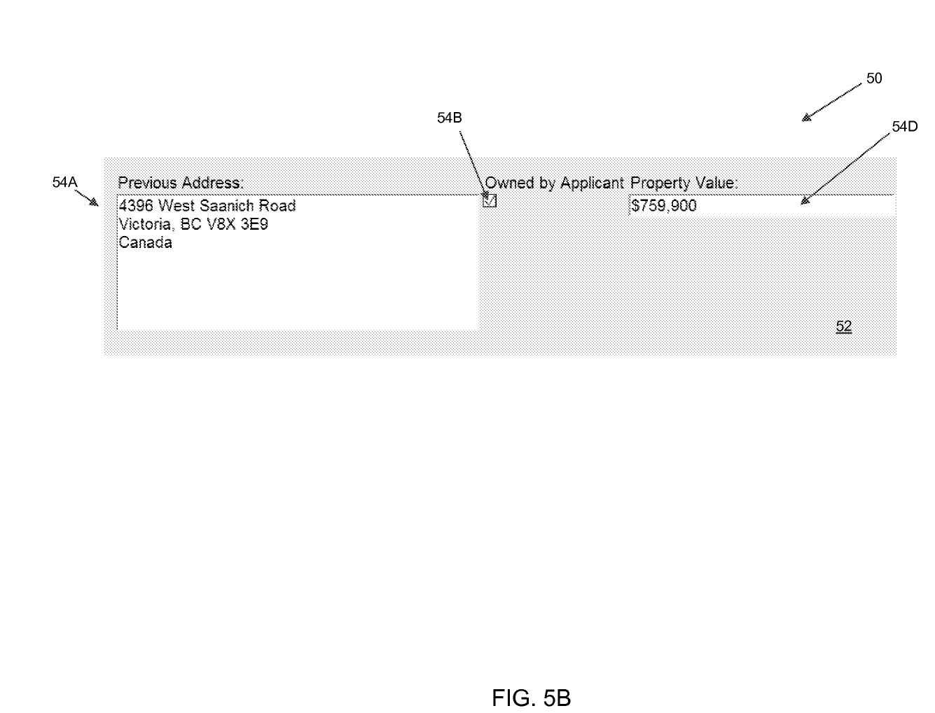

For illustrative purposes, another embodiment is shown at FIGS. 5A and 5B that depicts an application related to real estate. A user interface 52 has various U.I. items 54A, 54B, 54C, 54D positioned on a document 40. As such, the first U.I. item 54A depicts “Previous Address” information in table form; another U.I. item 54B depicts a check box, labeled “Owned by Applicant”; another U.I. item 54C depicts “Landlord Name” information in text form; and, a final U.I. item 54D depicts “Property Value” in text form. The first U.I. item 54A (i.e., “Previous Address”), being a container-type U.I. item 54 table comprises specific U.I. items 54 (e.g., street, city, country, etc.). As FIG. 5A shows, when the U.I. item 54B (i.e., “Owned by Applicant”) is not selected (i.e., no “check”), then the display property value for U.I. item 54C (i.e., “Landlord Name”) is set to “on”. The practical purpose for this interrelationship in this real estate application is that if the entity does not own the real property, then it would be beneficial to know who the landlord is. As shown in FIG. 5A, the U.I. item 54D (i.e., “Property Value”) is relatively positioned “below” the U.I. item 54C (i.e., “Landlord Name”). The term “below” comprises aligning the leading (e.g., left) edge of the “trailing” U.I. item 54D with that of the “target” U.I. item 54C, and also to align the top edge of the trailing” U.I. item 54D with padding below the bottom edge of that of the “target” U.I. item 54C.

In FIG. 5B, the U.I. item 54B (i.e., “Owned by Applicant”) is checked so that the display property value setting for U.I. item 54C (i.e., “Landlord Name”) (FIG. 5A) is “off”. The landlord field is dynamically switched off due to the programming added to the form. As depicted, not only did the “Landlord Name” U.I. item 54C cease to be visible, but the “Property Value” U.I. Item 54D moved upward in the document 40 to fill its space in the user interface 52. The layout term “below” comprises ignoring any padding below a non-displayed U.I. item 54C (i.e., U.I. item 54 having display property value set to “off”) and to align to the top edge of the non-displayed U.I. item 54C and further to continue to allow the relatively positioning U.I. item 54D to the left edge of the non-displayed U.I. item 54C.

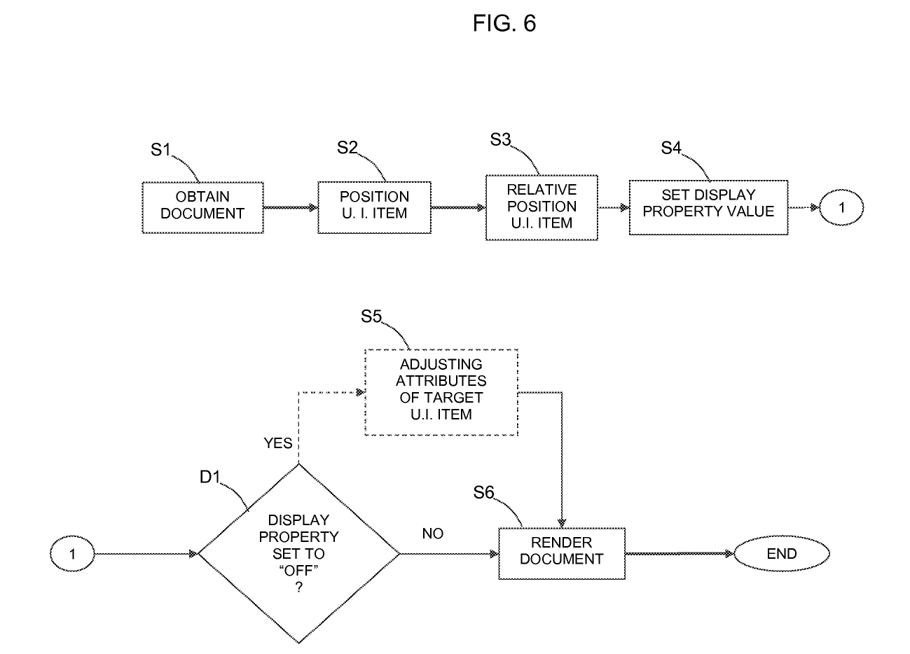

FIG. 6 shows an illustrative data flow for managing a user interface 52 (FIG. 2) according to an embodiment of the invention wherein at S1 a document module 32 (FIG. 2) obtains a document 40 for the user interface 52. At S2, a positioning module 34 (FIG. 2) positions a U.I. item 54 (FIGS. 3A-5B) at a first location on the document 40. At S3, the positioning module 34 (FIG. 2) relatively positions another U.I. item 54 (FIGS. 3A-5B) from the first U.I. item 54 positioned at S2 at a second location on the document 40. At S4 the display property module 36 (FIG. 2) sets a display property value of at least U.I. item 54 to one of: on or off. At D1, a determination is made by display property module 36 as to whether any of the display property value settings are at “off”. If a display property value is set to “off”, then optionally S5 may follow that comprises adjusting attributes of the target U.I. item 54. Subsequently and/or if there are no U.I. items 54 with a display property value is set to “off”, then the method proceeds to S6 comprising the document module 31 displaying the document 40. In this manner, the method includes relative positioning (S3) of U.I. item(s) 54 that is independent of display property value settings (S4).

In this manner, aesthetics of the layout of the user interface 52 and document 40 is improved by removing any large blank spaces found or created by setting the display property value to “off” for a U.I. item(s) 54. Under aspects of the invention, there is a separation of the notion of ‘display’ form that of layout flow for a U.I. item 54. The layout flows (e.g., block, inline) are allowed to persist for U.I. item(s) 54 that are not displayed (i.e., display property value set to “off”), thereby allowing locations, positioning, and/or relative positioning of U.I. items 53 amongst each other to become more flexible. Ultimately, resources (e.g., time, manpower, etc.) are saved in the layout and management of a user interface 52.

In another embodiment, the invention provides a computer program stored on a computer-readable medium, which when executed, enables a computer system to manage a user interface 52. To this extent, the computer-readable medium includes program code, such as user interface management program 30 (FIG. 2), which implements the process described herein. It is understood that the term “computer-readable medium” comprises one or more of any type of tangible medium of expression capable of embodying a copy of the program code (e.g., a physical embodiment). In particular, the computer-readable medium can comprise program code embodied on one or more portable storage articles of manufacture, on one or more data storage portions of a computing device, such as memory 22A (FIG. 2) and/or storage system 22B (FIG. 2), as a data signal traveling over a network (e.g., during a wired/wireless electronic distribution of the computer program), on paper (e.g., capable of being scanned and converted to electronic data), and/or the like.

In another embodiment, the invention provides a method of generating a system for managing a user interface 52. In this case, a computer system, such as computer system 12 (FIG. 2), can be obtained (e.g., created, maintained, having made available to, etc.) and one or more programs/systems for performing the process described herein can be obtained (e.g., created, purchased, used, modified, etc.) and deployed to the computer system. To this extent, the deployment can comprise one or more of: (1) installing program code on a computing device, such as computing device 14 (FIG. 2), from a computer-readable medium; (2) adding one or more computing devices to the computer system; and (3) incorporating and/or modifying one or more existing devices of the computer system, to enable the computer system to perform the process described herein.

In still another embodiment, the invention provides a business method that manages a user interface 52, which enables users to perform the process described herein on a subscription, advertising, and/or fee basis. That is, a service provider could offer to manage a network and/or a computer system 12 (FIG. 2) that allows users to manage a user interface 52 as described herein. In this case, the service provider can manage (e.g., create, maintain, support, etc.) a virtual and/or physical network that enables users to communicate content using computer systems, such as computer system 12, that perform the process described herein. In return, the service provider can receive payment from the user(s) under a subscription and/or fee agreement, receive payment from the sale of advertising to one or more third parties, and/or the like.

As used herein, it is understood that “program code” means any set of statements or instructions, in any language, code or notation, that cause a computing device having an information processing capability to perform a particular function either directly or after any combination of the following: (a) conversion to another language, code or notation; (b) reproduction in a different material form; and/or (c) decompression. To this extent, program code can be embodied as any combination of one or more types of computer programs, such as an application/software program, component software/a library of functions, an operating system, a basic I/O system/driver for a particular computing, storage and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of managing a user interface, the method comprising:
obtaining a document for a rendition, wherein the document includes a plurality of user interface items;
positioning a first user interface item at a first location on the document;
setting a display property value of the first user interface item to one of: on or off; and
relatively positioning from the first user interface item a second user interface item at a second location, wherein the relative positioning is independent of the display property value.

2. The method of claim 1, further comprising rendering the document on a rendition device.

3. The method of claim 1, when the display property is set to off, further comprising changing a height and a width of the first user interface item to zero.

4. The method of claim 1, at least one of the plurality of user interface items comprises one of: a button, a label, a line, a check, a field, a pop-up, a checkgroup, a radiogroup, a panel, tree control, a slider, a toolbar, or a table.

5. The method of claim 1, the relative positioning comprising arranging the second user interface item in relation to the first user interface item in one of a block placement or an inline placement.

6. The method of claim 1, the user interface items further comprising a bounding box, wherein the bounding box includes a padding along at least one side of the user interface item.

7. The method of claim 6, when the display property value is set to off, further comprising changing a height and a width of the bounding box to zero.

8. The method of claim 1, further comprising relatively positioning from one of the first user interface item or the second user interface item a third user interface item at a third location on the document.

9. The method of claim 1, at least one of the plurality of user interface items comprises a container for at least one other user interface item.

10. The method of claim 9, further comprising calculating a maximum of at least one of a height and a width of the container, the calculating further comprising ignoring any user interface item for which the display property value is set to off.

11. The method of claim 1, the relative positioning comprising arranging the second user interface item in relation to the first user interface item in one of a block placement or an inline placement; and
when the display property is set to off, further comprising changing a height and a width of the first user interface item to zero.

12. The method of claim 11, at least one of the plurality of user interface items comprises a container for at least one other user interface item; and
further comprising calculating a maximum of at least one of a height and a width of the container, the calculating further comprising ignoring any user interface item for which the display property value is set to off.

13. A system for managing a user interface, the method comprising:
a system for obtaining a document for a rendition, wherein the document includes at least two user interface items;
a system for positioning a first user interface item at a first location on the document;
a system for setting a display property value of the first user interface item to one of: on or off; and
a system for relatively positioning from the first user interface item a second user interface item at a second location, wherein the system for relative positioning is independent of the display property value.

14. The system of claim 13, further comprising a system for rendering the document on a rendition device.

15. The system of claim 13, when the display property value is set to off, further comprising a system for changing a height and a width of the first user interface item to zero.

16. The system of claim 13, the system for relative positioning comprising a system for arranging the second user interface item in relation to the first user interface item in one of a block placement or an inline placement.

17. The system of claim 13, the user interface items further comprising a bounding box, wherein the bounding box includes a padding along at least one side of the user interface item; and
when the display property value is set to off, further comprising a system for changing a height and a width of the bounding box to zero.

18. The system of claim 13, at least one of the plurality of user interface items comprises a container for at least one other user interface item.

19. A computer program comprising program code stored on a computer-readable medium, which when executed, enables a computer system to implement a method of managing a user interface, the method comprising:
obtaining a document for a rendition, wherein the document includes a plurality of user interface items;
positioning a first user interface item at a first location on the document;
setting a display property value of the first user interface item to one of: on or off; and
relatively positioning from the first user interface item a second user interface item at a second location, wherein the relative positioning is independent of the display property value.

20. A method of generating a system for managing a user interface, the method comprising:
providing a computer system operable to:
obtain a document for a rendition, wherein the document includes a plurality of user interface items;
position a first user interface item at a first location on the document;
set a display property value of the first user interface item to one of: on or off; and
relatively position from the first user interface item a second user interface item at a second location, wherein the relative positioning is independent of the display property value.
